(19) United States
(12) Patent Application Publication
(10) Pub. No.: US 2011/0213764 A1
(43) Pub. Date: Sep. 1, 2011

(54) Dynamic Search Health Monitoring

(75) Inventors: Brion Stone, Redmond, WA (US); Viktoriya Taranov, Bellevue, WA (US); Michal Piaseczny, Issaquah, WA (US); Menton Joseph Frable, Redmond, WA (US)

(73) Assignee: MICROSOFT CORPORATION, Redmond, WA (US)

(21) Appl. No.: 12/713,703

(22) Filed: Feb. 26, 2010

(51) Int. Cl. G06F 17/30

(52) U.S. Cl. 707/709; 707/713; 707/E17.017; 707/802; 707/E17.005

(57) ABSTRACT

A method for monitoring search performance on a server computer includes determining the processing time for a plurality of operations related to a search on the server computer. The determined processing time for each of the plurality of operations is stored in a database. Aggregate processing times are determined for the plurality of operations and the aggregate processing times are stored in the database.

### BACKGROUND

Search systems enable users to locate documents and other information quickly and efficiently. Because of the need to deal with a high volume of searches and because of the increasing amount of information available to be searched, many modern search systems have become scalable, including a plurality of server computers, many of which are grouped into server farms. In addition, search components used on server computers, for example search crawl components and search query components, have increased in number and complexity.

When using a search system, users typically demand a fast response. In order to provide the fast response times that users require, search system administrators have a need to understand the latency of the search system that they administer in order to improve the efficiency and performance of the search system. However, because of the scalability and increased complexity of search systems, obtaining an accurate assessment of search system performance has become difficult.

### SUMMARY

Embodiments of the disclosure are directed to a method for monitoring search performance on a server computer. The processing time is determined for a plurality of operations related to a search on the server computer. The determined processing time for each of the plurality of operations is stored in a database. Aggregate processing times are determined for the plurality of operations and the aggregate processing times are stored in the database.

The details of one or more techniques are set forth in the accompanying drawings and the description below. Other features, objects, and advantages of these techniques will be apparent from the description, drawings, and claims.

### DESCRIPTION OF THE DRAWINGS

FIG. 1 shows an example system that supports dynamic search health monitoring.

FIG. 2 shows example components of the server farm of FIG. 1.

FIG. 3 shows example components of the server computers of FIG. 2.

FIG. 4 shows a flowchart of a method for monitoring search performance on a server computer in the example system of FIG. 1.

FIG. 5 shows a flowchart of a method for determining execution time of code segments on a server computer during a search query.

FIG. 6 shows a flowchart of a method for determining execution time of handlers on a server computer during a search crawl.

FIG. 7 shows a flowchart of a method for calculating aggregate execution times for search query and search crawl operations.

FIG. 8 shows example components of the server computer of FIG. 3.

### DETAILED DESCRIPTION

The present application is directed to systems and methods for dynamically monitoring the health and performance of a search system. In examples, the search system includes one or more server computers and one or more databases. The server computers include crawl components that provide indexes for data in the search system and query components that parse search queries from a user and that obtain data requested in the search queries.

Search query and crawl components are comprised of a plurality of identifiable software code segments. During each search query and search crawl, the execution times for each identified code segment are obtained and stored in a database. The stored execution times for each code segment are made available for viewing by a system administrator. In addition, the stored execution times are aggregated and formatted in a manner that permits a system administrator to obtain multiple views of search system performance.

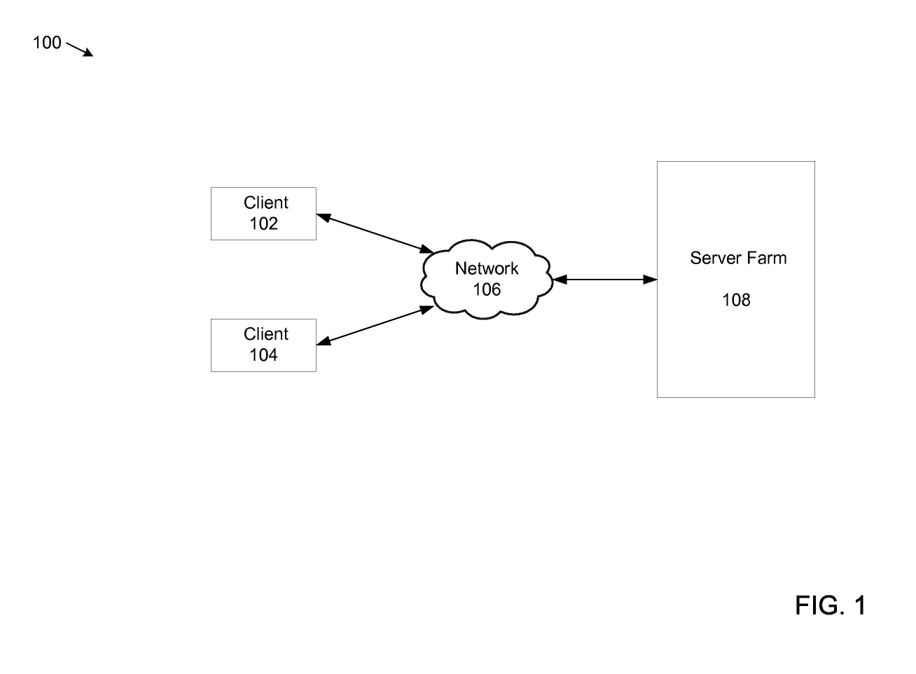

FIG. 1 shows an example system 100 that supports dynamic monitoring of search system performance. The system 100 includes client computers 102, 104, network 106 and server farm 108.

Client computers 102, 104 include software, such as Microsoft Office 2007 from Microsoft Corporation of Redmond, Wash., that supports document search and collaboration.

Server farm 108 includes one or more server computers and one or more databases. A plurality of the one or more server computers includes software that supports document search and collaboration. An example of a server computer that supports document search and collaboration is Microsoft Office Sharepoint Server 2010, also from Microsoft Corporation of Redmond, Wash.

Files and data located on the one or more server computers in the server farm 108 are accessible to client computers 102, 104 through network 106. One example of network 106 is a corporate Intranet network. More or fewer client computers, networks and server farms may be used. For example, a corporate network may have separate server farms for different geographical locations, for example one for the United States and one for Europe.

The one or more server computers in example server farm 108 supports a system search in the example system 100. In this disclosure, a system search is defined as a search query within a defined system, such as a corporate Intranet. The defined system can also include or one more server computers accessible over the Internet. In a system search, a user, for example a user on client computer 102 or client computer 104, typically formulates a search query and sends the search query to a search engine. In example system 100, the search engine is located on one or more server computers in the server farm 108.

Search systems typically include two aspects—a search crawl and a search query. In a search crawl, one or more server computers in the server farm 108 are accessed and document files on each accessed server computer are opened, analyzed and filtered. Data within each document file and metadata such as the title, author, time of creation, etc. are then indexed and stored in a database. During a search query, a query string is parsed into one or more keywords. Search crawl indexes are then accessed to locate indexed data corresponding to the parsed keywords from the query string.

In addition to document files, the server computers in server farm 108 include search crawl components and search query components. A search crawl component is software on a server computer that provides search crawl functionality, for example indexing. A search query component is software on a server computer that provides search query functionality, for example parsing a search query string and obtaining data requested in a search query.

The search crawl components and search query components are used to facilitate search crawl and search query in the server computers of the server farm. Because of the dynamic nature of searching, the search crawl and search query components accessed on the server computers in server farm 108 vary based on search tasks. In addition, to optimize the speed of a search and to provide scalability for large search systems, searches are often performed in parallel so that a plurality of search crawl components and search query components are accessed simultaneously. This permits searches to be performed on a smaller portion of a search crawl index and also permits document files to be crawled faster. In this disclosure, the terms search crawl components and crawl components are used interchangeably, and the terms search query components and query components are used interchangeably.

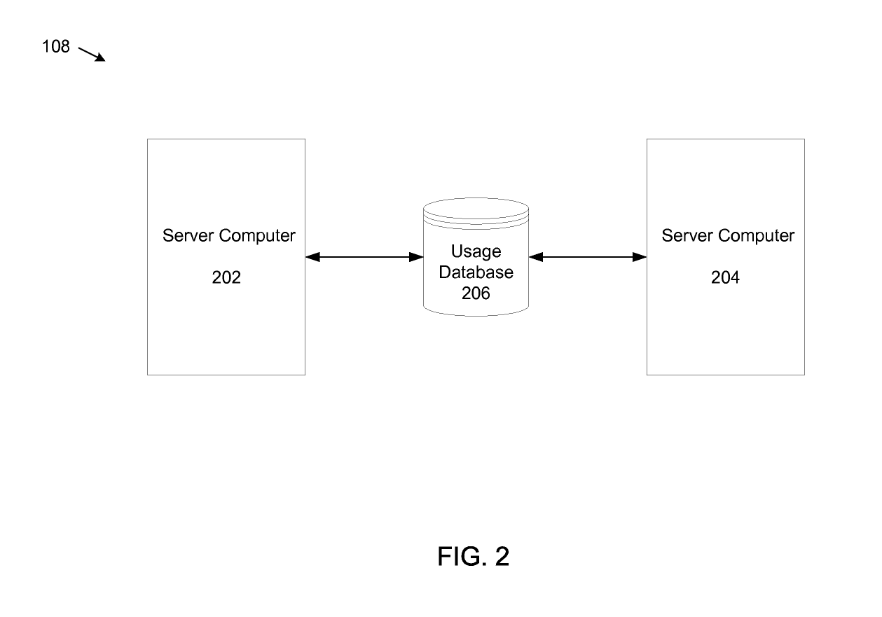

FIG. 2 shows example components of server farm 108. The example server farm 108 includes server computers 202, 204 and usage database 206.

The server computers 202, 204 store a plurality of files and documents that can be accessed by users of server farm 108, for example users at client computers 102, 104. The server computers 202, 204 also may include crawl components and query components that facilitate a system search for data in server farm 108. Depending on the size and configuration of server farm 108, each server computer 202, 204 may include only crawl components, only query components or a combination of crawl components and query components. For example, in some example server farms 108, a system administrator may prefer to have a group of server computers that support crawling, in which case these server computers would only include crawl components.

When a server computer includes multiple query components, each query component is often associated with a separate partition of the search crawl index. Splitting crawl indexes into separate partitions with separate query components facilitates scalability and permits search crawl and query operations to be performed in parallel.

The crawl components and query components on server computers 202, 204 each include identifiable code segments that are monitored during a search. Software on server computers 202, 204 determines when each code segment is accessed and determines the execution time of each code segment during a system crawl or a system search.

The execution times for each code segment executed on server computers 202 and 204 are stored on example usage database 206. Therefore, usage database 206 provides a central storage location for including search crawl and search query performance data. A system administrator can query usage database 206 to obtain and display the execution times for the code segments stored therein. The system administrator can also aggregate the individual execution times to provide a summary of search crawl and search query performance. In example server farm 208, usage database 206 may also store execution times from other server computers in server farm 208. In addition, server farm 208 may include multiple usage databases.

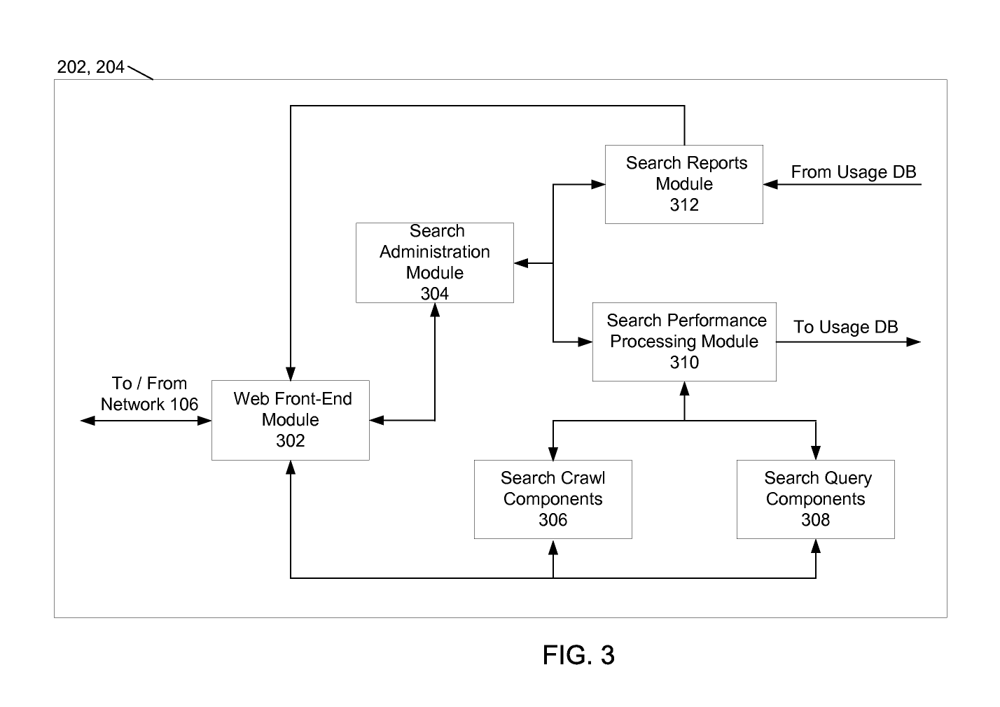

FIG. 3 shows example components of server computers 202, 204. Example server computers 202, 204 include web front end module 302, search administration module 304, search crawl components 306, search query components 308, search performance processing module 310 and search reports module 312. The example web front-end module 302 processes messages received over network 106 and transmits responses over network 106. For example, messages may be transmitted from and received by users on client computers 102, 104. Typical messages received include requests to create and open documents on server computers 202, 204 and to query data stored on or accessible from server computers 202, 204. Typical responses include data returned as a result of a query.

The example web-front end module 302 also includes an object model that directs search query and search crawl requests to appropriate search crawl components 308 and search query components 310. The web-front end module 302 also formats responses that are returned to a user as a result of a query.

The example search administration module 304 provides administrative support for server computers 202, 204 and may also provide administrative support for server farm 208. The administrative support for server computers 202, 204 includes identifying search crawl and search query components used on server computers 202, 204. The administrative support also includes configuring server computers 202, 204 for crawling and searching. For large installations, an administrator may configure one or more server computers to be dedicated for searching only or to be dedicated for crawling only.

The search administration module 304 also permits an administrator to format and display execution data stored on usage database 206 and to run reports on this data. In addition, in some examples, the search administration module 304 provides support for configuring the topology of server farm 108.

The example search crawl components 306 include one or more logical components that support a search crawl operation on server computers 202, 204. Search crawling includes retrieving files, for example documents on server computers 202, 204, filtering the retrieved files to obtain relevant data and indexing data in the files. Indexing data in the files includes obtaining metadata from the files and storing the metadata in the search crawl index. Examples of metadata are attributes such as the title of a document, the author of a document and relevant details from the document than can be indexed.

Search crawl operations are performed on a periodic basis to provide an up-to-date index of documents and data stored on server computers 202, 204. Search crawl operations are typically monitored at a more granular level than search query operations, the search crawl operations being timed for a general area of code. Two examples of search crawl operations that are timed include time spent in a handler and time spent in a plug-in. A handler defines a specific method of accessing a content source. For example, in Microsoft Sharepoint, one handler is used to access information from a content source, such as a list. Another handler is used to filter data in a list. A third handler is used to parse words from a stream of data. Each of these handler operations are timed and stored in usage database 206. A fourth handler, which is also timed, is used to store metadata from the handlers in the search crawl index.

A plug-in is a software module that adds a specific feature to a system. An example of a plug-in that is timed is a crawl component plug-in that stores search crawl metadata in the search crawl index.

The example search query components 308 include one or more components that support a search query operation on server computers 202, 204. One search query component, sometimes known as a query processor, routes search queries to one or more query components. Other search query components include code segments that implement search query operations. Example search query operations include parsing a search query, looking up a search crawl index, directing a search query to a specific part of the search crawl index and obtaining search query data. Other example query processor operations include returning search results, determining whether returned search results are high confidence search results, accessing search crawl index metadata, etc.

The example search performance processing module 310 monitors the execution times of operations in the search crawl and search query components on server computers 202, 204 and stores the execution times in usage database 206. During a search query, when a code segment of a search a search query component is accessed, the search performance processing module 310 starts a timer. When execution is completed in the code segment, the search performance processing module 310 stops the timer. Based on the start time for execution of the code segment and the stop time for execution of the code segment, the search performance processing module 310 calculates the execution time for the code segment. The search performance processing module 310 then stores the execution time for each code segment in usage database 206. In addition to the execution time, the search performance processing module 310 stores attributes associated with the execution time, such as an identifier for the server computer on which the execution time is measured, the date and time for which the measurement occurred, an identifier for the search query, etc.

During a search crawl, the search performance processing module 310 starts a timer when a handler is accessed. The search performance processing module 310 stops the timer when the handler operation is completed. The search performance processing module 310 then stored the execution time for each handler in usage database 206. The search performance processing module 310 also times other search crawl operations, such as time spent in a plug-in module.

On a periodic basis, typically one minute, the search performance processing module 310 also calculates aggregate values of execution times. An aggregate value is a summation of values that are averaged over a time period, typically one minute. For example, for server computer 202, for each periodic time interval, typically one minute, aggregate values are calculated for the number of queries processed on server computer 202 during the time interval, aggregate values are calculated for the time spent during each code segment executed for queries processed on server computer 202 during the time interval and aggregate values are calculated for the time spent in each handler executed during search crawl operations processed on server computer 202 during the time interval. When the aggregate values are calculated for the time interval, the aggregate values are stored in usage database 206.

The aggregate values of execution times are calculated on a per application and per server basis. A server farm may run a plurality of applications. Typically, applications are organized by functional area. For example, there may be separate applications for the human resources department, the legal department, the marketing department and the engineering department. Each application may use one or more server computers in the server farm. For example, if an application for the legal department uses components on server computer 202, aggregate values are calculated for the number of queries processed for the application on server computer 202 during each time interval, typically one minute. In addition, aggregate values are calculated for the time spent in each code segment executed during queries processed on server computer 202 for the application during the time interval. Aggregate values are also calculated for the time spent in each handler during search crawl operations processed on server computer 202 for the application during the time interval. The aggregate values calculated are stored in usage database 206.

The example search reports module 312 formats search data and generates search performance reports using data stored in the usage database 206. The search performance reports provide an administrator both a detailed and an overall picture of search system performance. Reports may be generated for individual search crawl and search query components, providing a detailed history for code segment execution in the search crawl and search query components. Reports may be also generated against aggregate execution data stored in the usage database 206.

Three example reports are Crawl Rate per Content Source, Crawl Rate per Type and Overall Query Latency. The Crawl Rate per Content Source report provides a view of recent crawl activity, sorted by content source. The Crawl Rate per Type report provides a view of recent crawl activity, sorted by items and actions for a given URL. These items and actions include modified items, deleted items, retries, errors and others. The Overall Query Latency report provides a view of recent query activity, showing latency from the major segments of the query pipeline and query averages per minute.

Reports may be filtered by application and by date and time. In addition, reports may be color coded to display execution times for selected code segments in different colors. Other ways of filtering reports are possible. For example filtering techniques such as drill downs, slice and dice, small to large and roll ups may be used.

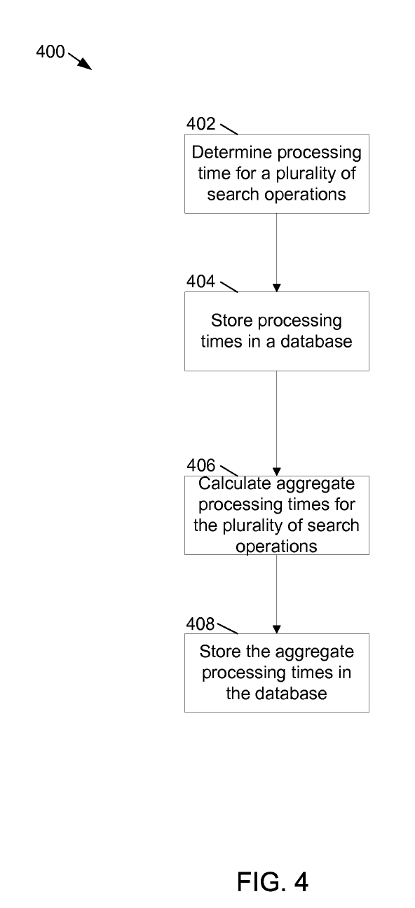

FIG. 4 shows an example flowchart of a method 400 for dynamically monitoring search system performance on a server computer, for example on server computer 202. At operation 402, the processing time is determined for a plurality of search operations on the server computer. The search operations include search crawl operations and search query operations. The search crawl operations may be performed on a plurality of partitions on server computer 202.

For the search crawl operations, the processing times are determined by monitoring the execution time of all handlers used in the search crawl operations. For search query operations, the processing times are determined by monitoring the execution time of code segments used in the search query operations. The search crawl operations include operations such as obtaining a document, opening the document, filtering the document to obtain information, storing metadata for the document in a database and creating an index for document and file data on the server computer. The search query operations include parsing a search query string, using a search crawl index to locate documents and files on the server computer and obtaining information from the located documents and files.

At operation 404, the processing time for the plurality of search operations is stored in a database, for example in usage database 206. At operation 406, aggregate processing times are calculated for the plurality of search operations. The aggregate processing times constitute an average of individually determined processing times over a predetermined time interval. For example, the execution times for each code segment used in a plurality of search operations are added and then divided by the predetermined time interval, typically one minute. At operation, 404, the aggregate processing times are stored in the database, for example usage database 206.

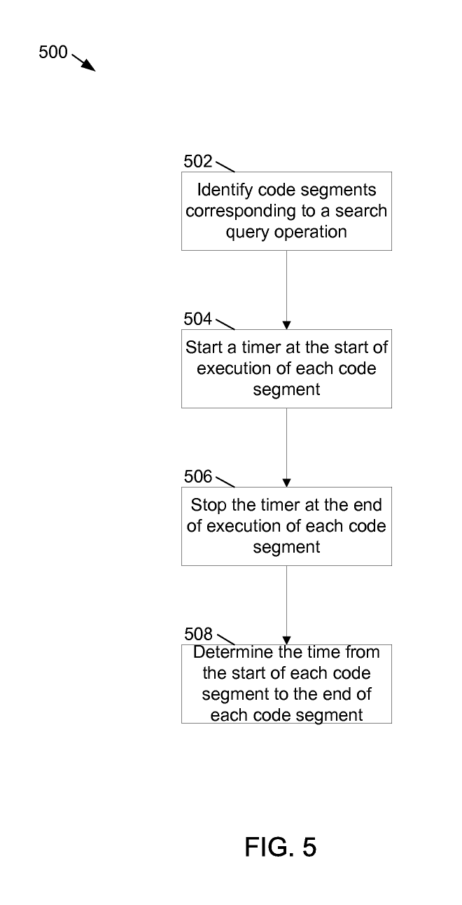

FIG. 5 shows an example flowchart of a method 500 for determining the processing time for code segments executed during search query operations on server computer 202. At operation 502, the code segments used during a search query operation are identified. Because search query operations are dynamic and are dependent on the type of data being requested, not all code segments are used in every search query. One example code segment is a code segment used to parse a search query string. Another example code segment is a code segment used to locate a document using an index.

At operation 504, a timer is started at the start of execution of a code segment. At operation 506, the time is stopped at the end of execution of the code segment. At operation 508, the value of the counter is readout and the execution time of the code segment is determined. Each executed code segment is timed in this manner. When multiple code segments are executed simultaneously, a separate timer is used for each code segment.

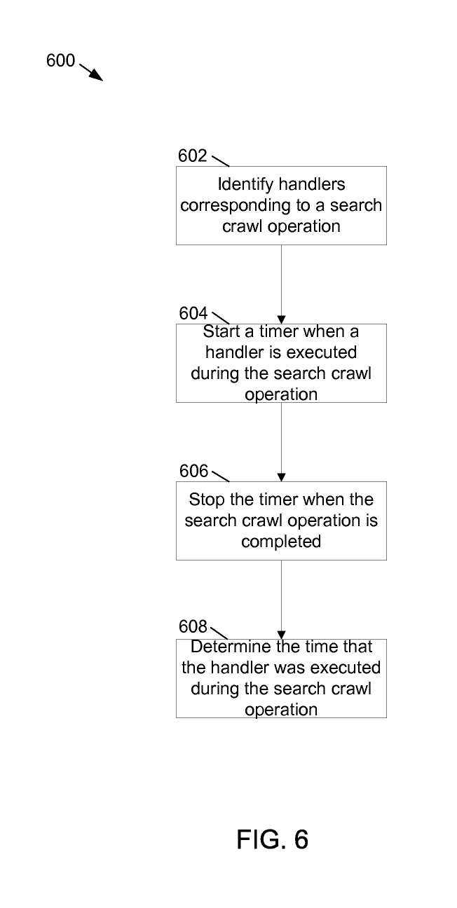

FIG. 6 shows an example flowchart of a method 600 for determining the processing time for handlers corresponding to a search crawl operation. A handler defines a specific method of accessing a content source, for example obtaining data from a list. At operation 602, handlers corresponding to the search crawl operation are identified. At operation 604, a timer is started when a handler used in a search crawl operation is executed. For example, a timer is started when a handler is executed to obtain information from a list on server computer 202.

At operation 604, the time is stopped when the handler has completed executing, for example when data is obtained from the list. At operation 606, the timer is readout and the time that the handler was executed during the search crawl operation is determined. When multiple handlers are executed simultaneously, a separate timer is used for each handler.

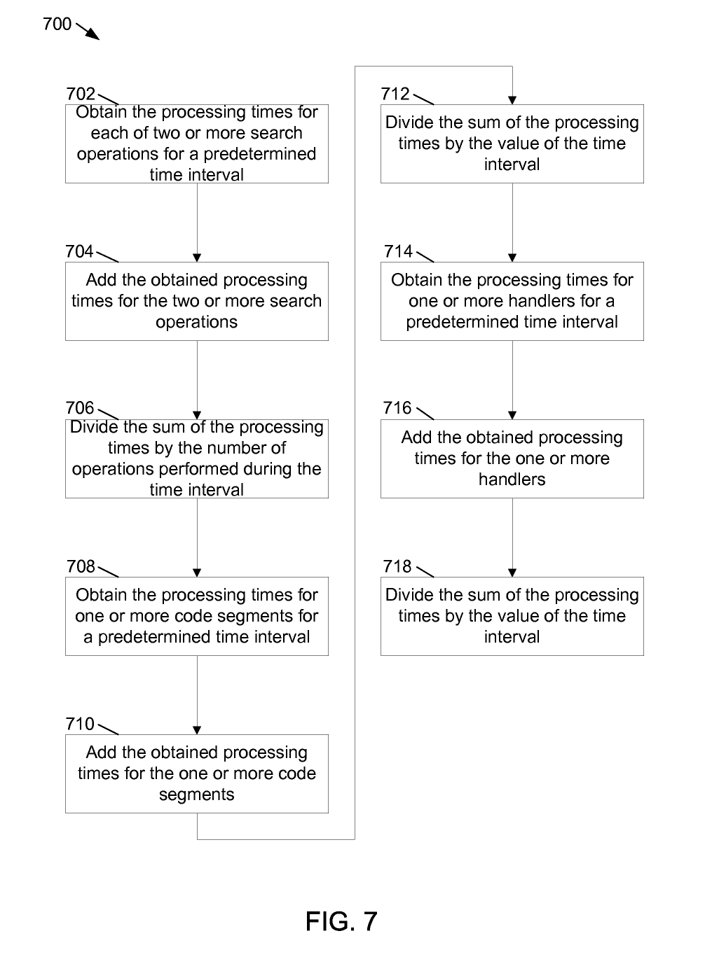

FIG. 7 shows an example flowchart of a method 700 for calculating aggregate processing times. In the example method, aggregate times are calculated for the number of search operations (operations 702-706), for code segments executed during search query operations (operations 708-712) and for handlers executed during search crawl operations (operations 714-718).

At operation 702, the processing times for each of two or more search operations for a predetermined time interval are obtained. The obtained processing times may represent the execution times for two or more search crawl operations, two or more search query operations or a combination of two or more search crawl operations and two or more search query operations. The predetermined time interval is typically one minute. The processing times may be obtained from a database, for example usage database 206, in which the times were stored when the search operations occurred.

At operation 704, the obtained processing times for each of the two or more search operations are added. For example, if within a one minute interval, two search query operations are executed, the first search query operation taking 5 seconds and the second search query operation taking 10 seconds, the total time for the two search query operations is 15 seconds.

At operation 706, the sum of the processing times is divided by the number of search operations performed during the predetermined time interval. In this example, dividing the total of 15 seconds by 2 gives an aggregate time of 7.5 seconds. Thus, for this example, in the one minute interval 7.5 seconds was the average time for the search operations performed.

At operation 708, the processing times for one or more code segments are obtained for a predetermined time interval, typically one minute. For example, one code segment may correspond to the code in a query processor. During the one minute interval, two search query operations may have occurred. For the first search query operation, one second may have been spent in the query processor and for the second search query operation, two seconds may have been spent in the query processor. In this example, in operation 708, processing times of one second and two seconds are obtained. In addition, processing times are obtained and aggregated for each additional code segment executed during the one minute interval. Processing times may be obtained from a database, for example usage database 206, in which the times were stored when the search query operations occurred.

At operation 710, the processing times obtained for the one or more code segments are added on a per code segment basis. That is, the processing times for the query processor are added and the processing times for each additional code segment executed during the one minute interval are added. In this example, the total processing time for the query processor in the one minute interval is 3 seconds.

At operation 712, the sum of the processing times for each code segment is divided by the time interval. In this example, because there were two search query operations during the minute, the aggregate processing time for the query processor during the minute is three seconds.

At operation 714, the processing times for one or more handlers is obtained for a predetermined time interval, typically one minute. The processing times correspond to the amount of time that the one or more handlers were executed during the one minute interval. For example, if three search crawl operations occurred within the one minute interval and a handler for locating a document on server computer 204 was executed for 1 second for the first search crawl operation, 3 seconds for the second search crawl operation and 2 seconds for the third search crawl operation, processing times of 1 second, 3 seconds and 2 seconds are obtained for the handler. The processing times are obtained from a database, for example usage database 206, in which the times were stored when the search crawl operations occurred. The processing times for each handler used during search crawl operations during the one minute interval are obtained.

At operation 716, the processing times obtained for the one or more handlers are added on a per handler basis. In this example, the total processing time for the handler used to locate a document on server computer 204 in the one minute interval is 6 seconds.

At operation 718, the sum of the processing times for each handler is divided by the time interval. In this example, because there were three search crawl operations during the minute, the aggregate processing time for the handler used to locate a document on server computer 204 during the minute is 6 seconds.

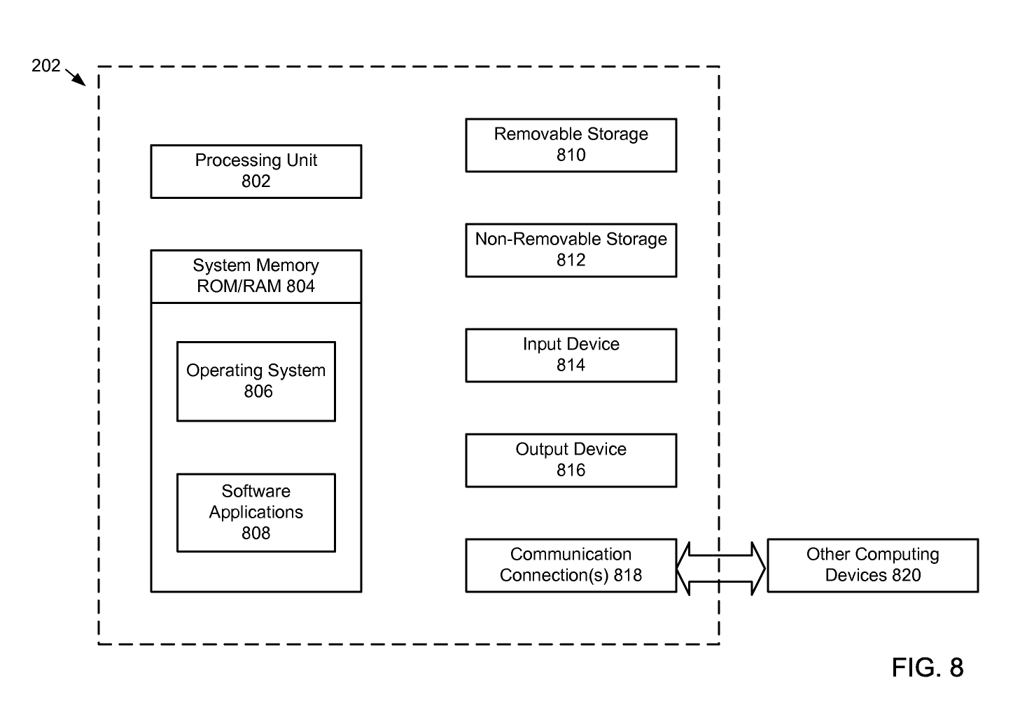

With reference to FIG. 8, example components of server computer 202 are shown. In example embodiments, the server computer is a computing device. The server computer 202 can include input/output devices, a central processing unit (“CPU”), a data storage device, and a network device. Client computers 102, 104 and server computer 204 can be configured in a similar manner.

In a basic configuration, the server computer 202 typically includes at least one processing unit 802 and system memory 804. Depending on the exact configuration and type of computing device, the system memory 804 may be volatile (such as RAM), non-volatile (such as ROM, flash memory, etc.) or some combination of the two. System memory 804 typically includes an operating system 806 suitable for controlling the operation of a networked personal computer, such as the WINDOWS® operating systems from Microsoft Corporation of Redmond, Wash. or a server, such as Microsoft Windows Server 2008, also from Microsoft Corporation of Redmond, Wash. The system memory 804 may also include one or more software applications 808 and may include program data.

The server computer 202 may have additional features or functionality. For example, the server computer 202 may also include computer readable media. Computer readable media can include both computer readable storage media and communication media.

Computer readable storage media is physical media, such as data storage devices (removable and/or non-removable) including magnetic disks, optical disks, or tape. Such additional storage is illustrated in FIG. 8 by removable storage 810 and non-removable storage 812. Computer readable storage media may include volatile and nonvolatile, removable and non-removable media implemented in any method or technology for storage of information, such as computer readable instructions, data structures, program modules, or other data. Computer readable storage media can include, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by server computer 202. Any such computer readable storage media may be part of device 202. Server computer 202 may also have input device(s) 814 such as keyboard, mouse, pen, voice input device, touch input device, etc. Output device(s) 816 such as a display, speakers, printer, etc. may also be included.

The server computer 202 may also contain communication connections 818 that allow the device to communicate with other computing devices 820, such as over a network in a distributed computing environment, for example, an intranet or the Internet. Communication connection 818 is one example of communication media. Communication media may typically be embodied by computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

The various embodiments described above are provided by way of illustration only and should not be construed to limiting. Various modifications and changes that may be made to the embodiments described above without departing from the true spirit and scope of the disclosure.

What is claimed is:

1. A method for monitoring search performance on a server computer, the method comprising:
determining processing time on the server computer for a plurality of operations performed on the server computer related to a search;
storing the determined processing time for each of the plurality of operations in a database;
calculating aggregate processing times for the plurality of operations; and
storing the aggregate processing times in the database.

2. The method of claim 1, wherein the plurality of operations includes operations related to a search query.

3. The method of claim 1, wherein the plurality of operations includes operations related to a search crawl.

4. The method of claim 1, wherein determining processing time for a plurality of operations performed on the server computer related to a search further comprises:
identifying one or more code segments corresponding to a search query operation;
starting a timer at the start of each of the one or more code segments;
stopping the timer at the end of each of the one or more code segments; and
determining the time from the start of each code segment to the end of each code segment.

5. The method of claim 1, wherein determining processing time for a plurality of operations performed on the server computer related to a search further comprises:
identifying one or more handlers corresponding to a search crawl operation;
starting a timer when each of the one or more handlers is executed for an operation;
stopping the timer for each of the one or more handlers at the end of the operation; and
determining the time that each of the one or more handlers is executed for each operation.

6. The method of claim 1, wherein calculating aggregate processing times for the plurality of operations further comprises:
obtaining the processing time for two or more of the plurality of operations performed on the server computer related to a search for a predetermined time interval;
adding the processing time for the two or more operations; and
dividing the sum of the processing time for the two or more operations by the number of operations performed during the time interval.

7. The method of claim 6, wherein each of the two or more operations is a search query and wherein the aggregate processing time represents an aggregate processing time for two or more search queries.

8. The method of claim 6, wherein each of the two or more operations comprises executing a code segment during a search query, the same code segment being executed during each of the two operations, and wherein the aggregate processing time represents an aggregate execution time for the code segment during the two or more operations.

9. The method of claim 6, wherein each of the two or more operations is search crawl and wherein the aggregate processing time represents an aggregate processing time for two or more search crawls.

10. The method of claim 6, wherein each of the two or more operations comprises executing a handler during a search crawl, the same handler being executed during each of the two operations, and wherein the aggregate processing time represents an aggregate execution time for the handler during the two or more operations.

11. The method of claim 6, wherein the predetermined time interval is one minute.

12. The method of claim 1, wherein the plurality of operations are performed on a plurality of partitions on the server computer.

13. A server computer that is configured to monitor search performance, the server computer comprising:
a processing unit;
a data storage system storing instructions that, when executed by the processing unit, cause the processing unit to:
create a web front-end module that processes search requests from a client computer over a network and that returns the results of the search requests to the client computer;
create one or more search crawl components that locate requested data for a search in one or more files on the server computer and that provide an index to the requested data;
create one or more search query components that parses the search requests and uses the index to locate the requested data on the server computer; and
create a search performance processing module that calculates search processing time in a plurality of code segments executed on the server computer as a result of a search, and that calculates aggregate performance time for the plurality of code segments, the search performance processing module storing the processing time for each monitored code segment in a usage database that is accessible to a plurality of server computers in a server farm, the search performance processing module also storing the calculated aggregate performance times in the usage database.

14. The server computer of claim 13, further comprising a search administration module that provides administrative support for crawling and searching on the server computer and on one or more additional server computers in a server farm.

15. The server computer of claim 13 further comprising a search reports module that formats search data for presentation to a user.

16. The server computer of claim 13, wherein the search performance processing module calculates search processing time in a plurality of code segments executed on the server computer by starting a timer when the start of each code segment is executed, stopping the timer when the execution of each code segment is completed and storing the execution time of each code segment in the usage database.

17. The server computer of claim 16, wherein the storing of the execution time of each code segment in the usage database further comprises storing one or more attributes associated with each code segment in the usage database.

18. The server computer of claim 13, wherein the search performance processing module further comprises calculating search crawl processing time in a plurality of handlers on the server computer by starting a timer when a handler operation is started, stopping the timer when the handler operation is completed and storing the execution time of each handler in the usage database.

19. The server computer of claim 13, wherein the search performance processing module calculating aggregate performance time for the plurality of code segments further comprises identifying one or more code segments, adding the calculated search processing times for each identified segment during a predetermined time interval, and dividing by the predetermined time interval.

20. A computer-readable data storage medium comprising instructions that, when executed by a processing unit of a server computer, cause the processing unit to:
determine processing time on the server computer for a plurality of operations performed on the server computer related to a search, the plurality of operations including operations related to a search query and operations related to a search crawl, the measuring of the processing time for search query operations causing the processing unit to:
identify one or more code segments corresponding to a search query operation,
start a timer at the start of each of the one or more code segments,
stop the timer at the end of each of the one or more code segments, and
determine the time from the start of each code segment to the end of each code segment, and
the measuring of the processing time for search crawl operations causing the processing unit to:
identify one or more handlers corresponding to a search crawl operation,
start a timer when each of the one or more handlers is executed for the search crawl operation,
stop the timer for each of the one or more handlers at the end of the search crawl operation, and
determine the time that each of the one or more handlers is executed for the search crawl operation;
store the measured processing time for each of the plurality of operations in a database;
calculate aggregate processing times for the plurality of operations, the calculating of aggregate processing times for the plurality of operations causing the processing unit to:
obtain the processing time for two or more search query operations performed on the server computer during a predetermined time interval,
add the processing time for the two or more search query operations, and
divide the sum of the processing time for the two or more search query operations by the number of search query operations performed on the server computer within the predetermined time interval,
obtain the processing time for two or more search crawl operations performed on the server computer during the predetermined time interval,
add the processing time for the two or more search crawl operations, and
divide the sum of the processing time for the two or more search crawl operations by the number of search crawl operations performed on the server computer within the predetermined time interval,
add the processing time for two or more code segments executed on the server computer during two or more search query operations, and divide the sum of the processing time for the two or more code segments by the predetermined time interval,
and
add the processing time for two or more handlers executed on the server computer during one or more search crawl operations, and divide the sum of the processing time for the two or more handlers by the predetermined time interval; and
store the aggregate processing times in the database.
